(19) United States
(12) Patent Application Publication
(10) Pub. No.: US 2012/0313355 A1
(43) Pub. Date: Dec. 13, 2012

(54) FASTENING ASSEMBLY FOR FASTENING A COMPONENT TO A SUPPORT WALL AND FASTENING ELEMENT THEREFOR

(76) Inventors: Martin Grabowski, Rietze (DE); Oliver Friese, Meine (DE)

(21) Appl. No.: 13/579,338

(22) PCT Filed: Jan. 26, 2011
(86) PCT No.: PCT/EP11/00338

§ 371 Date: Aug. 16, 2012

(30) Foreign Application Priority Data
Feb. 16, 2010 (DE) 10 2010 008 158.2

(51) Int. Cl. B60R 21/20

(52) U.S. Cl. 280/728.2

(57) ABSTRACT

The invention relates to a fastening assembly for fastening a component, for example an airbag (7), to a support wall (25) of a vehicle, comprising a fastening element (3) having a head part (17) and a shaft part (19), of which the shaft arms (29) pass through a fastening lug (21) of the airbag (7) and an assembly opening (23) of the support wall (25) and engage the edge of the assembly opening (23). According to the invention, the shaft arms (29) of the shaft part (19) on the head part (17) of the fastening element (3) transition into a common main body (27) by virtue of being composed of the same material and/or being integral.

The invention relates to a fastening arrangement for fastening a component, especially an airbag, to a support wall of a vehicle, according to the generic part of claim 1, as well as to a fastening element to be used in such a fastening arrangement, according to claim 11.

Such fastening arrangements can be employed to fasten a rolled-up or Z-folded head airbag in the area where the side wall makes a transition to the roof of the vehicle. For this purpose, a fabric tab on the head airbag is fastened to a part of the vehicle chassis by means of the fastening element.

German patent DE 10 2006 011 836 B3 discloses a fastening arrangement of the generic type, in which the fastening element has a head part as well as a shank part. The shank part is configured with shank arms which, in the assembled state, pass through a fastening tab on the airbag as well as through an assembly opening in the support wall, and these shank arms catch behind the edge of the assembly opening. Similar fastening arrangements are known from international patent applications WO 2006/026956 Al and WO 2008/028646 A1.

All of the fastening elements known in this context are made of sheet metal stamped parts that have elastically bending latching legs that are latched to the assembly opening in the support wall. Here, the ends of these latching legs catch around the edge of the assembly opening.

When the airbag is deployed, the fastening arrangement is subjected to severe mechanical stress. In this process, the fastening element installed in the assembly opening can become deformed to such an extent that its latching legs are unintentionally detached from the edge of the assembly opening in the support wall.

The invention is based on the objective of putting forward a fastening arrangement for fastening a component, especially an airbag, to a support wall of a vehicle, which ensures a reliable fastening of the component to the support wall, even when subjected to mechanical stress.

This objective is achieved by means of the features of claim 1 or of claim 11. Preferred refinements of the invention are disclosed in the subordinate claims.

According to the characterizing part of claim 1, the head part of the fastening element is formed by a shared baseplate or a base element that makes a lateral transition to shank arms that are at an angle with respect thereto. For this reason, the shank arms of the shank part are all shaped onto the shared baseplate. In the area of the head part of the fastening element, this gives rise to a dimensionally stable body that retains its shape inside the assembly opening, even when the fastening element executes crosswise movements. Even in the case of mechanical stress, the fastening element according to the invention is sufficiently stiff to avoid unintentional detachment of the latched connection.

As described above, the shank part of the fastening element is formed by individual shank arms that protrude from the base element. Each of these shank arms can have a stop wall facing outwards that projects at least partially into the assembly opening in the support wall. When the fastening element executes crosswise movements due to mechanical stress, these stop walls strike against the edge of the assembly opening, while no force is exerted on the actual latched connection between the fastening element and the support wall. This makes it possible to further counter any mechanical deformation of the latching legs of the fastening element.

The shank arms that form the shank part can be shaped onto opposite sides of the baseplate or of the base element. The baseplate can be configured so as to be essentially rectangular, whereby the baseplate can be extended by the shank arms on the opposite side edges. In order to further stiffen the above-mentioned body, the shank arms, especially their stop walls, can be supported against each other by means of stiffening struts. In this manner, the fastening element acquires a closed frame structure whose outer sides are opposite from the edge of the assembly opening.

In contrast to the invention, in the state of the art, it is not the head part, but rather the opposite shank tip that is formed by a baseplate. Sheet metal strips extend from this closed shank tip all the way to the head part of the fastening element, thereby reaching over the edge of the assembly opening. As a result, in contrast to the invention, it is not the head part that is stiffened, but rather, the shank tip. The end pieces of the sheet metal strips held on the edge of the opening have a great deal of play when they are subjected to mechanical stress in comparison to the configuration of the state of the art, as a result of which the fastening element can become unintentionally detached.

The shank arms that protrude from the baseplate can delimit an enclosed space that is protected against external mechanical stresses. In the enclosed space of the shank part, there can preferably be a latching element that can detachably catch behind the edge of the assembly opening. Preferably, the latching element is configured as an elastically bending latching leg that can protrude with at least one latching projection through a matching recess in the shank arms. In this manner, on the one hand, the latching projection can catch behind the edge of the assembly opening, while, on the other hand, the elastically bending latching leg is arranged so as to be protected in the enclosed space of the shank part. For this reason, when the fastening element is subjected to mechanical stress, the elastically bending latching leg cannot strike against the edge of the assembly opening, thus reliably preventing the fastening element from becoming unintentional detached.

In order to dismantle the fastening element, the above-mentioned elastically bending latching leg can have an actuating section that can likewise be arranged in the enclosed space of the shank part and that is therefore essentially inaccessible from the outside. In order to carry out the dismantling of the fastening element, the baseplate can be provided with at least one tool access opening through which a tool can be inserted all the way to the actuating section of the latching leg.

The elastically bending latching leg can preferably be configured as the end piece of each shank arm. At the shank tip that is opposite from the head part, the end piece of the shank arm can be folded back in the direction of the head part. Therefore, the latching leg runs approximately counter to the outer shank arm inside the enclosed space of the shank part.

In order to ensure that the baseplate is reliably supported on the top of the support wall, the baseplate can have correspondingly overhanging support arms that can rest on the support wall.

It is preferable for the fastening element of the fastening arrangement to be in the form of a single piece made of metal or plastic. Preferably, the fastening element can be configured as a stamped and bent part in which the opposite shank arms are bent mirror-image away from the baseplate around bending axes that are parallel to each other. In order to form the shank tip, the shank arms are bent towards the baseplate around other bending axes that are parallel to each other, thus forming the latching legs located inside the enclosed space of the shank part. The latching projections of these latching legs can be bent laterally towards the outside around additional bending axes.

An embodiment of the invention is described below on the basis of the accompanying figures.

The following is shown:

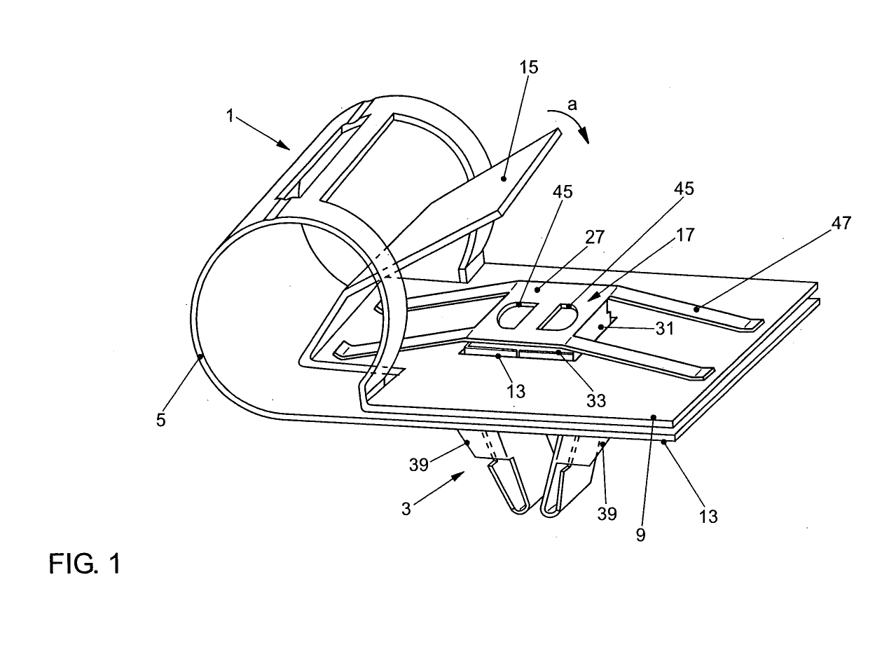

FIG. 1: a perspective view of a retaining bracket for a head airbag (not shown here), and a fastening element for fastening it to a support wall (not shown here);

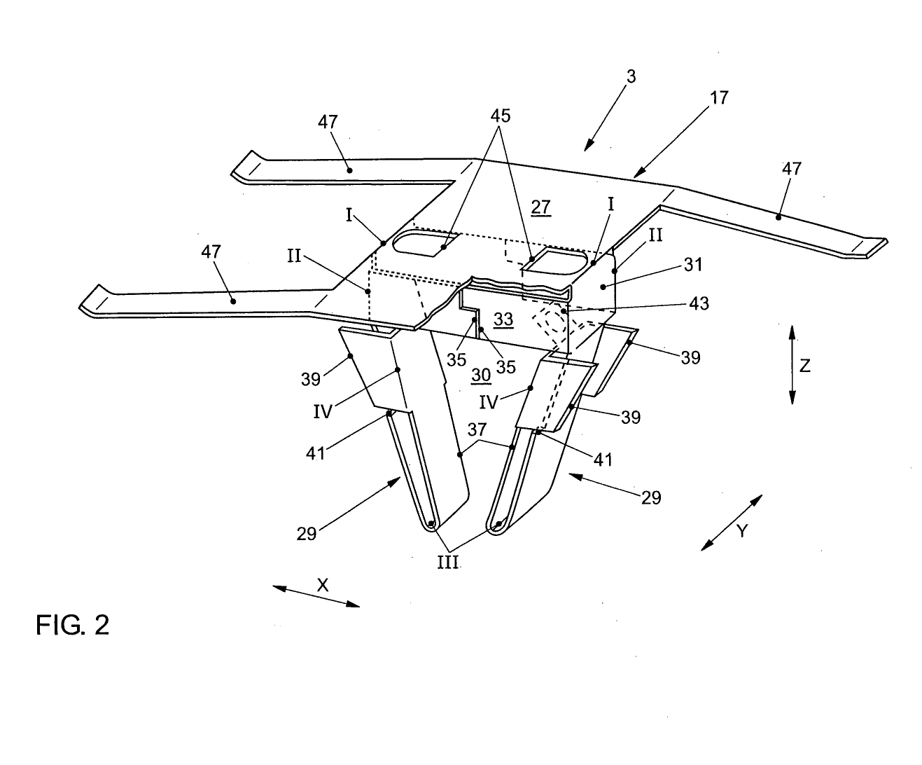

FIG. 2: the fastening element depicted on its own;

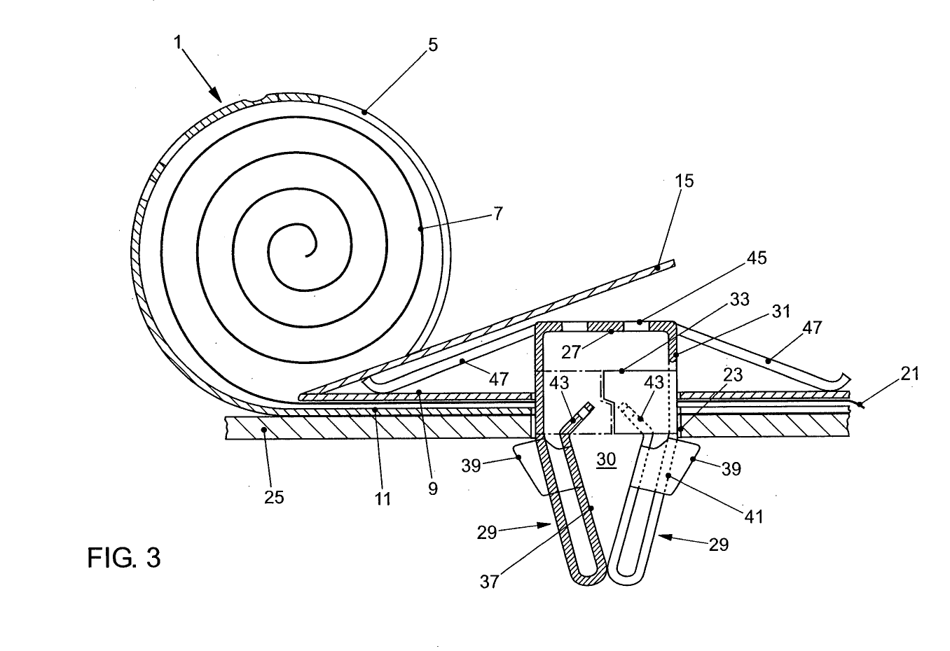

FIG. 3: the fastening arrangement in its assembled state as well as in a sectional view; and

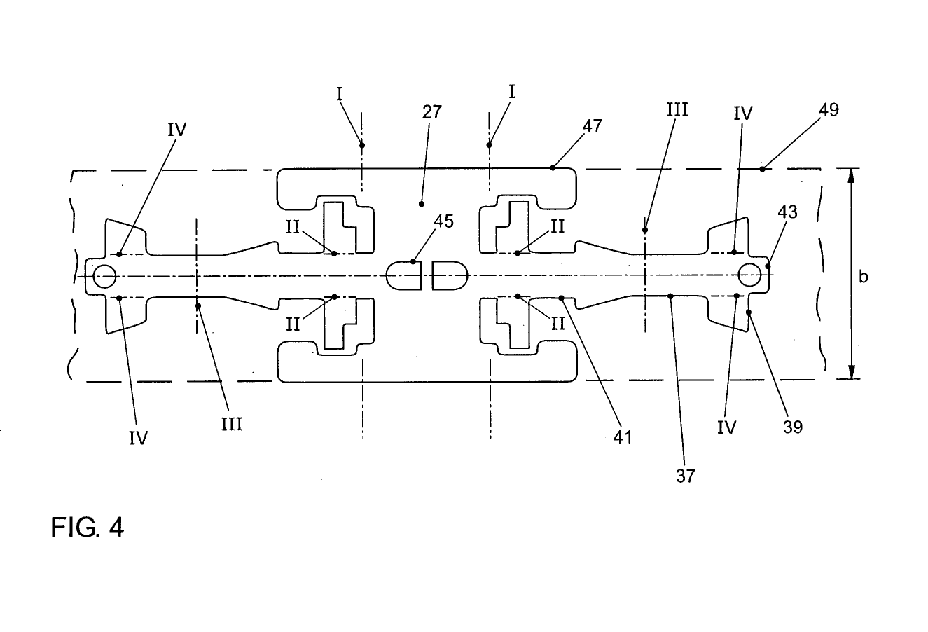

FIG. 4: the fastening element configured as a sheet metal stamped part, in a developed view.

FIG. 1 shows a familiar retaining bracket 1 as well as a fastening element 3 that is configured as a shaped sheet metal part. The retaining bracket 1 is made of soft plastic and has a cylindrical section 5 that catches around a divided head airbag 7 that is rolled up, as depicted in FIG. 3. Outwards projecting fastening flanges 9, 11 whose rectangular openings 13 lie on top of each other are formed on the cylindrical section 5 of the retaining bracket. The cylindrical section 5 also has a cutout from which a V-shaped tab 15 has been bent. Its free leg that projects outwards at a slant is pressed in the arrow direction a downwards onto the head part 17 of the fastening element 3 when the head airbag 7 has been installed. Consequently, the head part 17 of the fastening element 3 is largely covered by the tab 15, as a result of which the head airbag 7 is protected against damage from sharp edges of the fastening element.

Aside from its head part 17, the fastening element 3 has a shank part 19 that, in FIG. 1, runs through the opposite rectangular openings 13 of the fastening flange 9, 11.

As can also be seen in the sectional view of FIG. 3, a fabric tab 21 on the head airbag 7 is arranged between the two fastening flanges 9, 11 and the shank part 19 of the fastening element 3 likewise passes through said tab. The shank part 19 of the fastening element 3 also runs through an assembly opening 23 in the support wall 25 of the vehicle, whereby latching projections 39 of the shank part 19 that protrude laterally outwards catch underneath the edge of the assembly opening 23.

The structure of the fastening element 3 will be described below on the basis of FIG. 2. According to this figure, the head part 17 of the fastening element 3 is formed by a shared baseplate 27 that is configured as a rigid base element configured to be approximately rectangular with four side edges. The baseplate 27 makes a transition to the shank arms 29 on the opposite side edges in the spatial direction x. These shank arms are bent at a right angle around bending axes I that run parallel to each other. The shank arms 29 form the shank part 19 of the fastening element 3. Directly at the transition to the baseplate 27, the two shank arms 29 each have stop walls 31. These walls protrude into the assembly opening 23 in the support wall 25 in the assembled state as shown in FIG. 3, having a slight play in the crosswise direction. The fastening element 3 is thus employed as a floating bearing in the assembly opening 23 in the support wall 25. In the case of crosswise movements, the stop walls 31 of the fastening element 3 strike against the edge of the assembly opening 23.

As can also be seen in FIG. 2, the stop walls 31 of the two shank arms 29 are extended by means of stiffening struts 33 in the lateral direction x. These edges 35, which face each other, have a butt joint, as a result of which the shank arms 29 can be supported against each other in the lateral direction x. In this manner, together with the stop walls 31 and the baseplate 27 on the head side, an extremely stable body is provided which remains dimensionally stable inside the assembly opening 23, even under mechanical stress. The stiffening struts 33 are each bent at an approximately right angle relative to the stop walls 31 around additional bending axes II.

Over the further course downwards, the shank arms 29 are extended all the way to the shank tip. In the area of the shank tip, the end pieces of the shank arms 29 are pulled inwards around third bending axes III and are bent upwards in the direction of the baseplate 27. The end pieces that are bent upwards form elastically bending latching legs 37 that extend into the enclosed space 30 delimited between the shank arms 29. Therefore, in contrast to the state of the art, the fastening element 3 is configured so as to be open at the shank tip and closed by the baseplate 27 at the head part 17.

Each latching leg 37 arranged in the enclosed space 30 has the lateral latching projections 39 that are bent from the elastic latching legs 37 around fourth bending axes IV by about 90°. As shown in FIG. 2, the bent latching projections 39 protrude through lateral recesses 41 that have each been made in the side edges of the shank arms 29.

Bent actuating sections 43 that project upwards are located in the further extension on the ends of the two latching legs 37. These sections are accessible through matching tool access openings 45 in the baseplate 27. Therefore, in order to dismantle the fastening element 3, a suitable pair of pliers has to be inserted through the two access openings 45 all the way to the actuating sections 43 in the enclosed space 30 of the fastening element 3. When the tool is employed appropriately, the two latching legs 37 can then be moved towards each other, as a result of which the latching projections 39 are disengaged from the edge of the assembly opening 23.

For purposes of achieving a stable support, the baseplate 27 has laterally projecting support arms 47 which, in the assembled state shown in FIG. 3, are supported in such a way that spring pre-tension is built up on the top of the fastening flange 9 of the retaining bracket 1. The support arms 47 as well as the shank arms 29 here are bent from the baseplate 27 around axially parallel bending axes.

FIG. 4 shows a developed view of the fastening element 3 configured as a sheet metal shaped part. Accordingly, the fastening element 3 is first stamped out of a narrow sheet metal plate 49 in a stamping procedure. Subsequently, the shank arms 29 that protrude from the central baseplate 27 as well as the support arms 47 are bent in a bending procedure. The appertaining bending axes I, II, III, IV are indicated by a broken line. As can be seen in FIG. 4, the width b of the sheet metal plate here corresponds to the width of the fastening element 3, as a result of which, all in all, only very little cutting waste is created during production.

### LIST OF REFERENCE NUMERALS

1 retaining bracket
3 fastening element
5 cylindrical section
7 head airbag
9, 11 fastening flange
13 rectangular opening
15 V-shaped tab
17 head part
19 shank part
21 fabric tab
23 assembly opening
25 support wall
27 baseplate
29 shank arms
30 enclosed space
31 stop walls
33 stiffening struts
35 stop edges
37 latching legs
39 latching projections
41 recesses
43 actuating sections
45 access openings
47 support arms
49 sheet metal plate
a directional arrow
b width
x lateral direction
y depth direction
z height direction
I-IV bending axes

1. A fastening arrangement for fastening a component such as an airbag to a support wall of a vehicle, comprising
a fastening element that has a head part as well as a shank part having shank arms that pass through a fastening tab of the airbag as well as through an assembly opening in the support wall and catch behind the edge of the assembly opening,
wherein the shank arms of the shank part on the head part of the fastening element make a transition to a shared base element so as to be made of the same material and/or as a single piece.

2. The fastening arrangement according to claim 1, wherein each of the shank arms has a stop wall that projects into the assembly opening in the support wall and that strikes against the edge of the assembly opening when the fastening element executes crosswise movements inside the assembly opening.

3. The fastening arrangement according to claim 1, wherein the shank arms are shaped onto opposite sides of the base element.

4. The fastening arrangement according to claim 1, characterized in that wherein the shank arms that protrude from the base element delimit an enclosed space of the shank part.

5. The fastening arrangement according to claim 4, wherein, in the enclosed space of the shank part, there is at least one elastically bending latching leg that protrudes with at least one latching projection through a matching recess in the shank arms, said latching projection catching behind the edge of the assembly opening.

6. The fastening arrangement according to claim 5, wherein the elastically bending latching leg has an actuating section that is arranged in the enclosed space of the shank part.

7. The fastening arrangement according to claim 5, wherein the elastically bending latching leg is an end piece of a shank arm that is folded back in the direction of the head part at the shank tip that is opposite from the head part.

8. The fastening arrangement according to claim 6, wherein the base element has at least one tool access opening that allows access to the actuating section of the latching leg.

9. The fastening arrangement according to claim 1, wherein the base element has a support section with which the base element can be supported on the top of the support wall.

10. The fastening arrangement according to claim 1, wherein the fastening element is configured in the form of a single piece.

11. A fastening element for a fastening arrangement according to claim 1.

12. The fastening arrangement according to claim 1, wherein the shank arms, especially their stop walls, are supported against each other by means of stiffening struts.
